(19) United States
(12) Patent Application Publication
(10) Pub. No.: US 2006/0139337 A1
(43) Pub. Date: Jun. 29, 2006

(54) Operation display device

(75) Inventor: Osami Fukao, Osaka (JP)

Correspondence Address: GLOBAL IP COUNSELORS, LLP, 1233 20TH STREET, NW, SUITE 700, WASHINGTON, DC, 20036-2680, US

(73) Assignee: Kyocera Mita Corporation, Osaka (JP)

(21) Appl. No.: 11/302,470

(22) Filed: Dec. 14, 2005

(30) Foreign Application Priority Data
Dec. 14, 2004 (JP) 2004-360824

(51) Int. Cl. G09G 5/00

(52) U.S. Cl. 345/173; 345/156; 345/168

(57) ABSTRACT

An operation display device comprises an operation control unit which executes a function corresponding to a selection key displayed on a display unit, and a guide display control unit which displays a guide message corresponding to the selection key. The operation control unit causes the guide display control unit to display a guide message corresponding to a selection key in accordance with the amount of time that the selection key has been operated by a user. The guide display control unit displays the guide message corresponding to the selection key in a region other than the region in which the operated selection key and one or more other selection keys related thereto are displayed.

### BACKGROUND OF THE INVENTION

1. Field of the Invention

The present invention relates to an operation display device comprising a display unit, a display control unit for displaying a plurality of selection keys arranged on the display unit, and a guide display control unit for displaying a guide message corresponding to the selection key.

2. Background Information

Recently, in the field of image forming devices such as copying machines and printers, it have been proposals to display an instruction manual or guide messages about various functions on a display console of a touch panel that forms an integrated operation unit and display unit.

For example, as shown in Japan Unexamined Patent Publication No. H10-307512, it has been proposed to assist the user to set a complicated function by automatically displaying on a display console and aurally outputting a guide to explain how to set the function, when a setting window for the function is displayed after a certain period of time has elapsed since the setting window was opened.

However, in the above conventional technology, it is very difficult to precisely determine which detailed function the user wants to know about among the plurality of functions, because the instruction manual is displayed after a certain period of time has elapsed after the setting window that displays the functions is opened. In other words, in each of the windows, the higher the level of the function that the window displays, the more detailed functions would be displayed, so that it becomes more difficult to understand if the instruction manuals of all of the detailed functions are displayed. In addition, a lapse of a certain period of time is not necessarily caused by the user's confusion about the operation, thereby causing the display of unnecessary instruction manuals.

In order to correct the above-mentioned deficiency in the conventional technology, one of the objects of the present invention is to provide an operation display device that appropriately finds information the user wants to know about in order to display the instruction manual and ensure a high degree of ease of use.

### SUMMARY OF THE INVENTION

According to a first aspect of the present invention, an operation display device comprises a display unit, a display control unit which displays a plurality of selection keys arranged on the display unit, and a guide display control unit which displays a guide message corresponding to each of the selection keys. The guide display control unit displays the guide message corresponding to a selection key when that selection key is selected, with the guide message being displayed in a region other than the region in which the selected selection key and one or more other selection keys related thereto are displayed.

With the above structure, the user can identify the selection keys related to the function to be executed, and more specifically, the selection keys to be selected next, while viewing an instruction manual or guide message about the function that he or she wants to know, so that operability is improved.

According to a second aspect of the present invention, an operation display device comprises a display unit, a display control unit which displays a plurality of selection keys arranged on the display unit, an operation control unit which executes a function corresponding to a selection key when operated by a user, and a guide display control unit which displays a guide message corresponding to each of the selection keys. The operation control unit causes the guide display control unit to display a guide message corresponding to a selection key based upon the amount of time that the selection key has been operated by a user. In addition, the guide display control unit displays the guide message corresponding to a selection key when that selection key is selected, the guide message being displayed in a region other than the region in which the selected selection key and one or more other selection keys related thereto are displayed.

With the above structure, the user can obtain additional information about a function when he or she wants it, and can identify the selection keys related to the function, i.e., the keys to be selected next, so that the operability is improved.

According to a third aspect of the present invention, the operation display device according to the second aspect further comprises an operation mode setting means for setting the operation control unit so that the operation control unit is capable of executing a function corresponding to a selection key at the same time the guide display control unit displays a guide message.

This allows the operation control unit to selectively display a guide message corresponding to the selection key on the display screen while the selected function is executed, or to display a guide message on the display screen without executing the selected function. The former saves the user from having to operate the same selection key after reading the guide message.

According to a fourth aspect of the present invention, the operation control unit according to the second aspect executes a function corresponding to a selection key operated by a user when the selection key is operated less than a predetermined amount of time, and causes the guide display control unit to display a guide message corresponding to a selection key operated by a user when the selection key is operated for an amount of time that is equal to or greater than the predetermined amount of time.

According to a fifth aspect of the present invention, the operation control unit according to the second aspect executes a predetermined function corresponding to a selection key at the same time as the selection key is selected.

According to a sixth aspect of the present invention, the operation control unit according to the second aspect causes the guide display control unit to display a guide message corresponding to a selection key while the selection key is being operated by a user, and executes a function corresponding to the selection key after a user stops operating the selection key.

As explained above, the present invention provides an operation display device that finds and displays information about functions that the user wants to know, thereby ensuring a high degree of usability.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 shows a digital copying machine.

FIG. 2 shows an operation panel on the digital copying machine of FIG. 1.

FIG. 3 shows the circuit configuration of the operation panel.

FIG. 4 shows a block configuration of an operation display device according to a first embodiment of the present invention.

FIG. 5 is a flow chart for explaining the operation of the operation display device of the first embodiment.

FIG. 6 shows the display status of the operation display device of the first embodiment.

FIG. 7 is a flow chart for explaining the operation of an “instant execution mode” of the operation display device of the first embodiment.

FIG. 8 shows a block configuration of the operation display device according to a second embodiment of the present invention.

FIG. 9 is a flow chart for explaining the operation of the operation display device of the second embodiment.

### DETAILED DESCRIPTION OF THE PREFERRED EMBODIMENTS

### First Embodiment

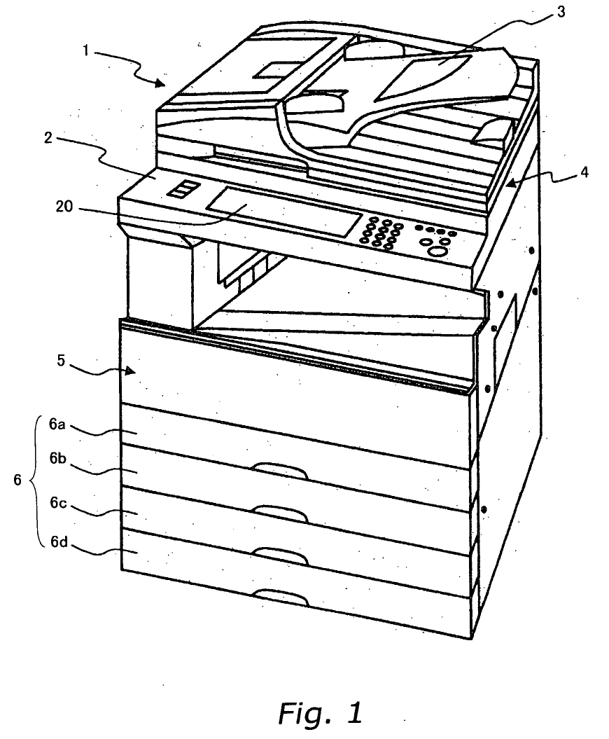

The first embodiment will be described hereinafter, in which an operation display device 30 according to the present invention is applied to a digital copying machine 1. The digital copying machine 1 includes, as shown in FIG. 1, an operation panel 2 having copy mode setting keys for setting various copy modes and print keys for initiating copy operation in the copy mode set by, and an image reading unit 4 (also referred to as “scanner”) for sequentially reading a series of documents set on a document platen 3 and converting them into electronic data, an image forming unit 5 of an electrophotographic system located below the image reading unit 4 which serves to form a toner image on paper in accordance with the image data from the image reading unit 4 and then output the printed paper, a plurality of paper cassettes 6 (6a to 6d) containing different sizes or types of papers, and a manual feeding portion (not shown) installed on the left side of the machine body.

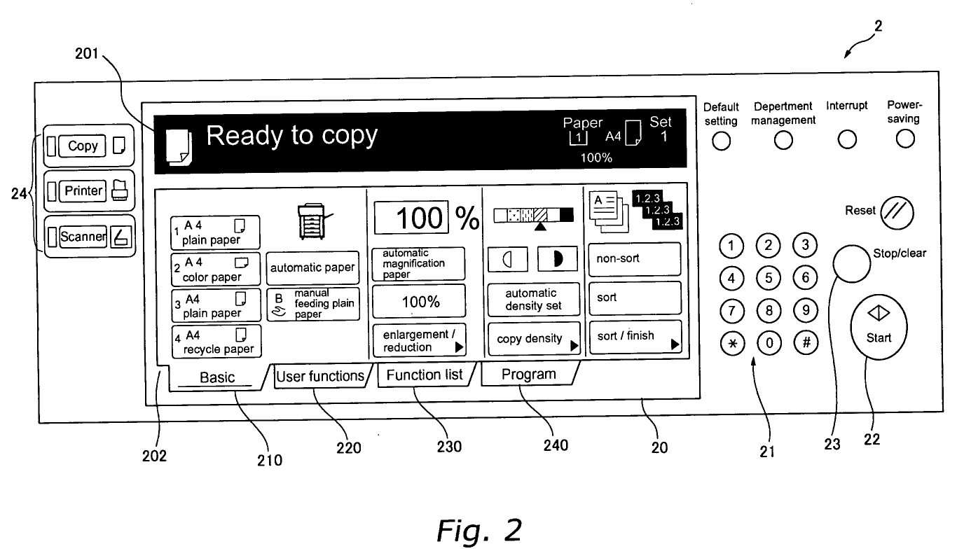

The operation panel 2 is located on the front side of the image reading unit 4, and includes, as shown in FIG. 2, a color touch panel type LCD 20 at the center thereof and a group of basic control keys for copy operations, including number input keys 21 for setting the copy quantity, a start key 22, and a stop/clear key 23 on the right of the LCD 20, a status display unit 24 for displaying whether the machine is operating in a copy mode in which the image read from the document is output to paper, in a printer mode in which the output data from a computer connected to a network is output to paper, or in a scanner mode in which the document data is read and output to the network, and a special mode setting key on the upper side of the LCD 20.

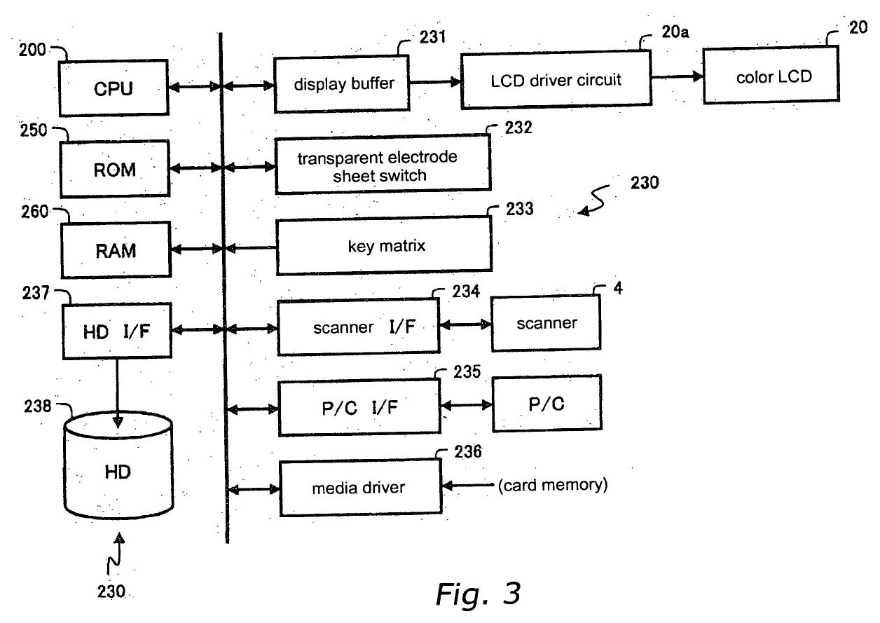

The circuit configuration of the operation panel 2 is, as shown in FIG. 3, composed of a CPU 200 for executing input-output controls to various keys on the operation panel 2 and the LCD 20 and for sending copy mode data set by a CPU for controlling the image reading unit 4 and the image forming unit 5, a ROM 250 for storing programs that can be executed by the CPU 200, a volatile RAM 260 used as a working area, different kinds of input and output circuits 230, with the components interconnected with each other via internal buses. The input and output circuits 230 include a display buffer 231 for supplying a driver circuit 20a of the color LCD 20 with display data, an input circuit 232 to transparent electrode sheet switches formed over the surface of the LCD 20, a key matrix input circuit 233 for receiving various key inputs, a scanner interface circuit 234 connected with the image reading unit 4, an interface circuit 235 connected with an external personal computer, a media driver 236, and an interface circuit 237 connected with a hard disk unit 238.

Returning to FIG. 2, the LCD 20 has an upper portion of the screen that is used as a message display area 201, and a lower portion that is used as a mode setting key area 202. The mode setting key area 202 includes various setting tab areas such as a basic mode setting tab 210 for setting up basic conditions in the copy operation such as magnification, paper size, exposure level, a user function tab 220 for allowing the user to individually set and register detailed information on the basic mode, a function list tab 230 in which detailed operation modes of the color copying machine are set and input, and a program tab 240 by which the user can set an original copy mode. The LCD 20 has transparent electrode sheets installed on the display screen, which are pressed so as to detect a pressed portion. Accordingly, for example, a paper size selection key is constituted by a paper size selection unit displayed on the basic mode setting tab 21 0 and the corresponding transparent electrode sheet.

The operation display device 30 is configured as a control unit of the operation panel 2, and displays the setting tabs and selection keys (selection buttons) of the detailed functions contained in the setting tabs, and further displays the guide messages of the detailed functions on the LCD 20 by operation of the operation panel 2.

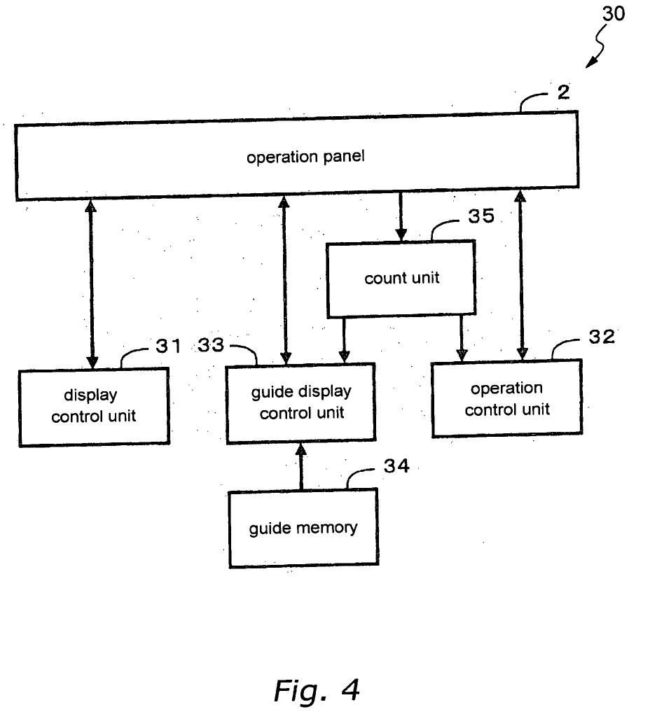

The function block configuration of the operation display device 30 is, as shown in FIG. 4, composed of a display control unit 31 for displaying the selection keys arranged on the LCD 20, an operation control unit 32 for executing a function in response to operation of a selection key, a guide display control unit 33 for displaying a guide message corresponding to the selection key, a guide memory 34 for storing the guide messages, a count unit 35 for measuring the time during which the selection key is selected, and the operation panel 2 as the operation unit and display unit.

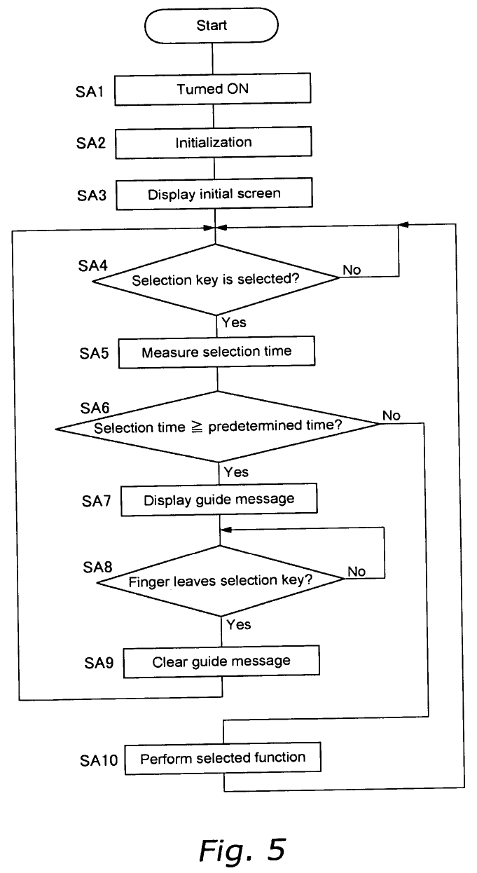

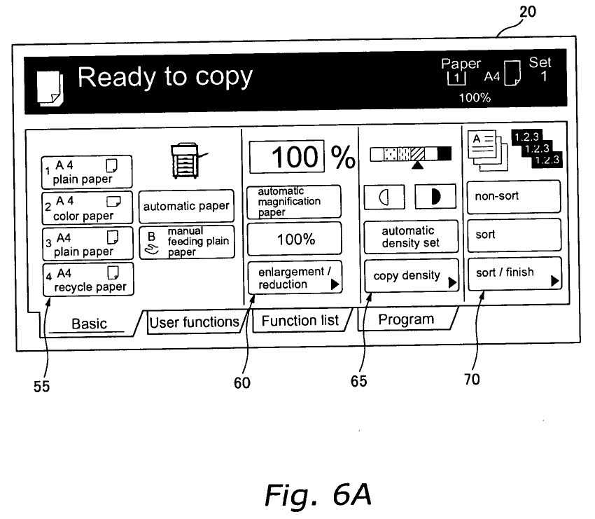

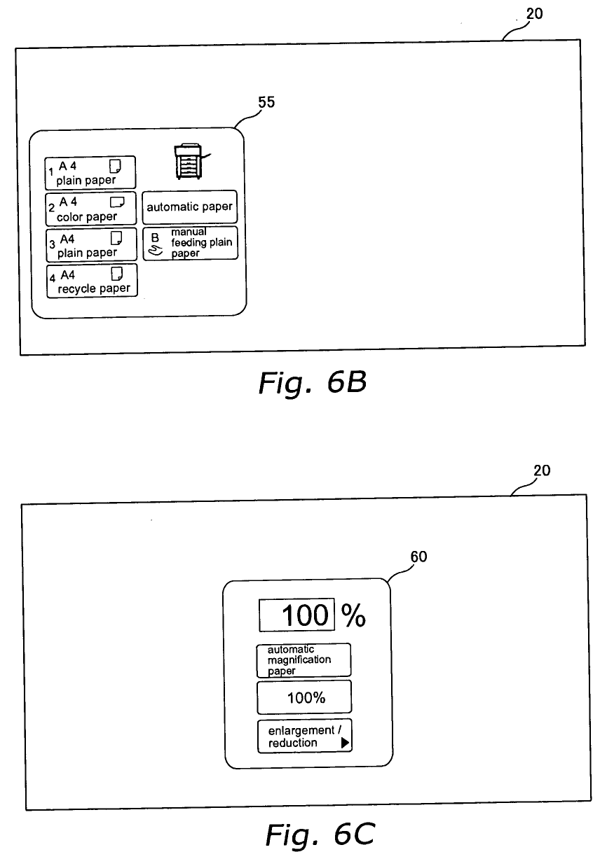

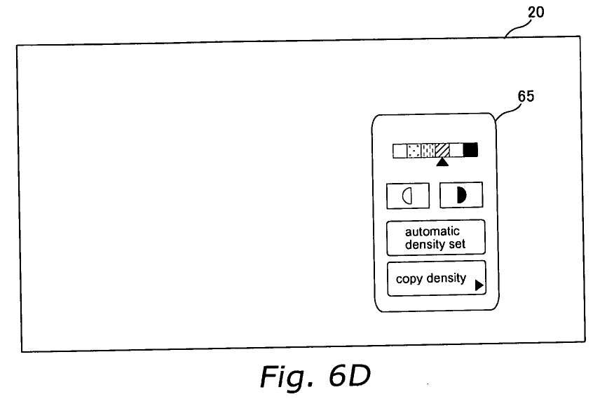

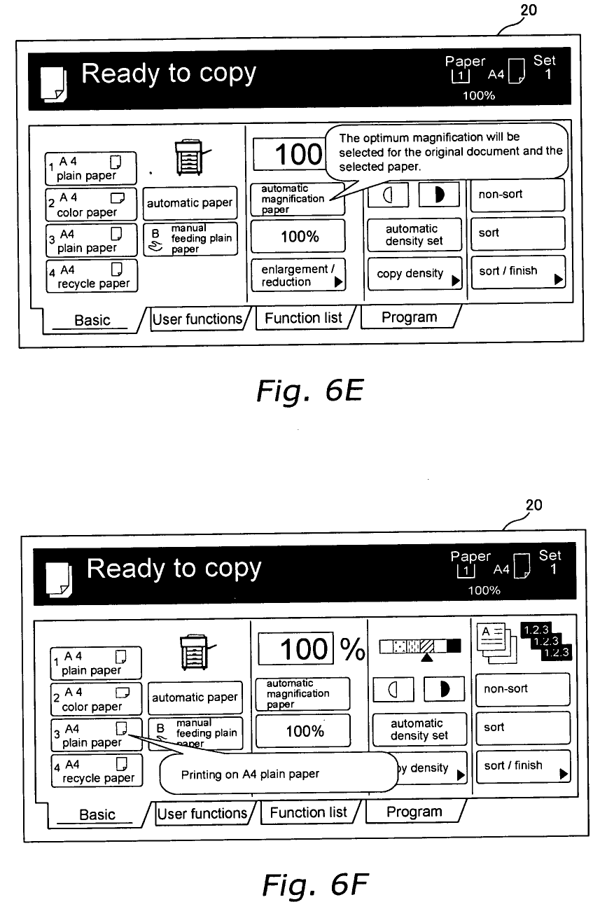

The operation of the operation display device 30 will be described referring to a flow chart in FIG. 5 and screens displayed on the color LCD 20 in FIG. 6. When the digital copying machine 1 is turned ON (SA1), after initializations at each function block (SA2), the display control unit 31 controls the LCD 20 to display an initial screen consisting of the setting tabs and the selection keys of detailed functions contained in the setting tabs (SA3, FIG. 6A).

When one of the selection keys displayed on the LCD 20 is selected (SA4), the count unit 35 measures the time during which the selection key is selected (SA5). If the time is less than a predetermined time, i.e., when pressed for a short period of time, the operation control unit 32 executes the selected function to update the display status of the LCD 20 (SA6, SA10). In contrast, when the time is equal to or greater than the predetermined time, i.e., when pressed for a long period of time, the guide display control unit 33 displays a guide message stored in the guide memory 34 about the function corresponding to the selected selection key, in a region other than the region in which the selected selection key and one or more other selection keys related thereto are displayed (SA6, SA7). It should be noted that the “selection key(s) related to the selected selection key” refers to one or more selection keys which can be selected based upon the guide message displayed with regard to the selected selection key.

For example, the screen shown in FIG. 6A includes an output paper selection area 55 in which selection keys regarding the setting of the output sheets are arranged, an output magnification setting area 60 in which selection keys regarding the output magnification setting are arranged, an output density setting area 65 in which the selection keys regarding output density setting are arranged, a sort setting area 70 in which are arranged the selection keys for setting the method by which the output sheets are to be sorted, and a message display area 201.

The output paper selection area 55 includes, as shown in FIG. 6B, an area composed of keys for manual tray selection such as a “1. A4 plain paper” selection key, a “2. A4 color paper” selection key, a “3. A4 plain paper” selection key, a “4. A4 recycled paper” selection key, a “manual feeding plain paper” selection key, and an “automatic paper” selection key for automatically selecting papers.

The output magnification setting area 60 includes, as shown in FIG. 6C, a manual magnification setting display panel that sets the magnification by directly input from the operation unit, an “automatic magnification” selection key, an automatic magnification display panel that displays the converted magnification when the automatic magnification is selected, and an “enlargement/reduction” selection key that displays a more detailed function screen regarding the reduction and enlargement functions.

The output density setting area 65 includes, as shown in FIG. 6D, a density display bar for visually displaying density, a cursor key for manually selecting density, an “automatic density” selection key for automatically selecting density, and a “copy density” key for displaying a more detailed function screen regarding the copy density function.

The sort setting area 70 similarly includes a “non-sort” selection key and a “sort” selection key for selecting whether or not to sort, and a “sort/finish” selection key for displaying a more detailed function screen regarding document finishing.

Therefore, for example, if the “automatic magnification” selection key in the output magnification setting area 60 is selected for more than a first predetermined time, a guide message regarding the automatic magnification is displayed, such as “the optimum magnification will be selected for the original document and the selected paper”, in a region other than the region in which the selected selection key and one or more other selection keys related thereto are displayed. as shown in FIG. 6E. If the “A4” plain paper selection key in the output paper selection area 55 is selected for more than the first predetermined time, a guide message such as “Printing on standard A4 paper” will be displayed in a region other than the region in which the selected selection key and one or more other selection keys related thereto are displayed, as shown in FIG. 6F.

Although the first predetermined time can be selected arbitrarily, if it is too short, the guide message is almost always displayed. Conversely, if it is too long, it takes a long time to display the guide message. Consequently, it is preferable that the first predetermined time is set to approximately 0.3 to 0.5 seconds.

Next, when the finger leaves the selection key (SA8), the guide message is cleared (SA9), and the process returns to Step SA4.

Although the above-mentioned guide message will be displayed until the finger leaves the selected selection key, the guide message may be automatically cleared after a second predetermined time elapses. The second predetermined time is different from the first predetermined time and is measured based upon the timing of the operation of the selection key or the time at which the user's finger left the selection key.

A modification of the first embodiment will now be described. Although in the first embodiment the operation control unit 32 is set to the “short pressing mode”, which executes the function corresponding to the selection key after the count unit 35 determines the selected key is pressed for a short time, and displays a guide message when the selection key is pressed for a long time, the operation control unit 32 may be set into an “instant execution mode” to execute the function at the same time as the selection key is selected.

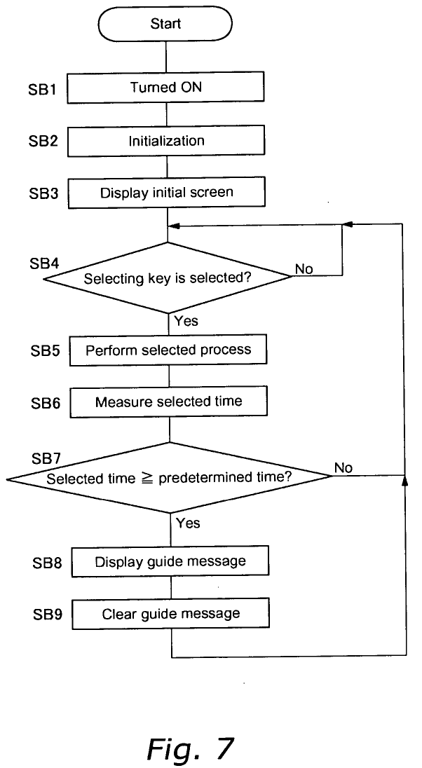

The “instant execution mode” will be described referring to a flow chart in FIG. 7. When the digital copying machine 1 is turned ON (SB1), after initialization at each function block (SB2), the display control unit 31 controls the LCD 20 to display an initial screen consisting of the setting tabs and the selection keys for detailed functions contained in the setting tabs (SB3).

When one of the selection keys displayed on the color LCD 20 is selected (SB4), the operation control unit 32 executes the selected function to update display status of the color LCD 20 (SB5).

The count unit 35 measures time during which the selection key is selected (SB6). If the time is equal to or more than the first predetermined time, i.e., when pressed for a long period of time, the guide display control unit 33 displays a guide message stored in the guide memory 34 about the function corresponding to the selected selection key in a region other than the region in which the selected selection key and one or more other selection keys related thereto are displayed (SB7, SB8). The guide message is cleared at the time that the user's finger leaves the selection key or after the second predetermined time elapses (SB9).

The operation display device 30 may also operate in the “execution after short pressing mode” and the “instant execution mode”, wherein the selected operation is executed and the guide message is displayed together, and the two operation modes may be selected arbitrarily. For example, the modes may be selected beforehand by the operation of the mode selection key in the user function tab.

More specifically, this makes it possible to select whether a guide message is displayed on the screen while the operation control unit 32 performs the selected function corresponding to the selection key, or the guide message is displayed on the screen without executing the selected function. The former case saves the user from operating the same selection key again after confirming the message.

### Second Embodiment

Although in the first embodiment, the display or non-display of the guide message corresponding to the function of the selection key, or the execution or non-execution of the function of the selection key are controlled based upon the short pressing status or long pressing status of the selection key, the guide message is displayed and the selected function is executed every time the selection key is selected in the second embodiment.

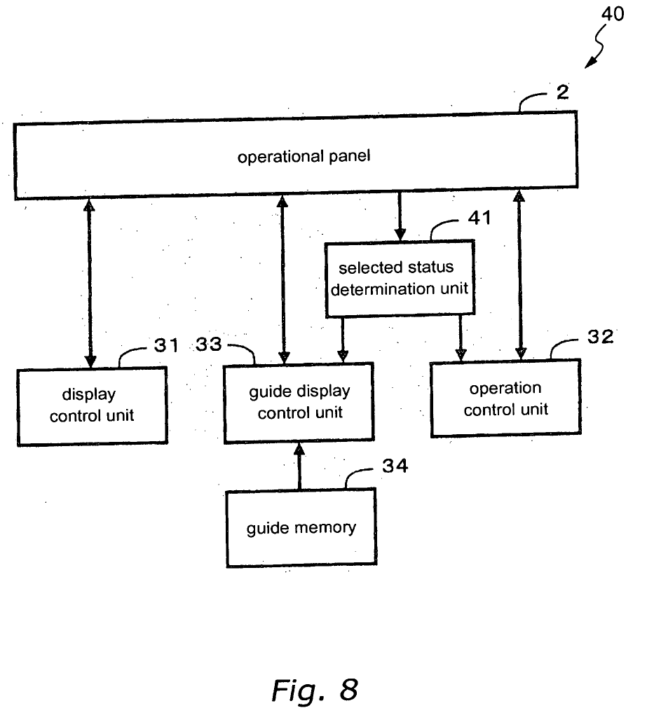

As shown in FIG. 8, the operation display device 40 in the second embodiment includes a selection status determination unit 41 for determining the status of the pressed selection keys, instead of the count unit 35 of the operation display device 30 in the first embodiment.

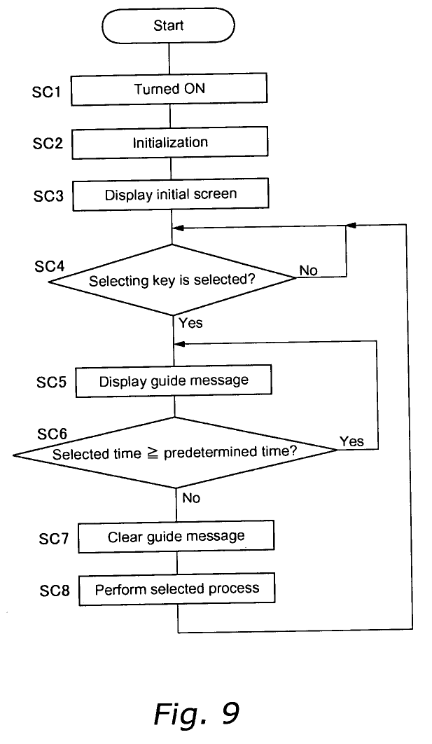

The operation of the operation display device 40 will be explained referring to the flow chart in FIG. 9. When the digital copying machine 1 is turned ON (SC1), after initialization at each function block (SC2), the display control unit 31 controls the LCD 20 to display an initial screen consisting of the setting tabs and the selection keys for the detailed functions contained in the setting tabs (SC3).

When one of the selection keys displayed on the LCD 20 is selected (SC4), the guide display control unit 33 displays a guide message stored in the guide memory 34 about the function corresponding to the selected selection key, in an area other than where the selection key associated with the function is displayed, after a predetermined time has elapsed after the selection key is pressed, if the selected status determination unit 41 determines that the selection key is selected (SC5, SC6). The guide display control unit 33 clears the guide message at the same time as it is determined that the selected status of the selection key is finished (SC7).

Furthermore, the operation control unit 32 performs the function corresponding to the selected selection key at the same time as the selected status determination unit 41 determines that the selected status of the selection key is finished (SC8).

### Other Embodiments

In the above-mentioned embodiments, the arrangement, names, and shapes of the selection keys are simply examples, and the present invention is not limited to those examples and may be modified. In addition, other functions can be added to the functions described above and functions can be deleted.

Although a situation is described in the above-mentioned embodiments wherein the operation display device is applied to a digital copying machine, the operation display device can be applied to image processing devices such as a facsimile machine having a scanner device, and a multifunction machine having printer and facsimile functions.

Moreover, the operation display device according to the present invention can be applied to a personal computer on which icons are displayed and which includes a selecting means for selecting icons and executing programs associated with the icons.

Any terms of degree used herein, such as “substantially”, “about” and “approximately”, mean a reasonable amount of deviation of the modified term such that the end result is not significantly changed. These terms should be construed as including a deviation of at least ±5% of the modified term if this deviation would not negate the meaning of the word it modifies.

This application claims priority to Japanese Patent Application No. 2004-360824. The entire disclosure of Japanese Patent Application No. 2004-360824 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An operation display device, comprising:
a display unit;
a display control unit which displays a plurality of selection keys arranged on the display unit; and
a guide display control unit which displays a guide message corresponding to each of the selection keys;
wherein the guide display control unit displays the guide message corresponding to a selection key when that selection key is selected, the guide message being displayed in a region other than the region in which the selected selection key and one or more other selection keys related thereto are displayed.

2. An operation display device, comprising:
a display unit;
a display control unit which displays a plurality of selection keys arranged on the display unit;
an operation control unit which executes a function corresponding to a selection key when operated by a user; and
a guide display control unit which displays a guide message corresponding to each of the selection keys;
wherein the operation control unit causes the guide display control unit to display a guide message corresponding to a selection key based upon the amount of time that the selection key has been operated by a user; and
the guide display control unit displays the guide message corresponding to a selection key when that selection key is selected, the guide message being displayed in a region other than the region in which the selected selection key and one or more other selection keys related thereto are displayed.

3. An operation display device according to claim 2, further comprising an operation mode setting means for setting the operation control unit so that the operation control unit is capable of executing a function corresponding to a selection key at the same time the guide display control unit displays a guide message.

4. An operation display device according to claim 2, wherein the operation control unit executes a function corresponding to a selection key operated by a user when the selection key is operated less than a predetermined amount of time, and causes the guide display control unit to display a guide message corresponding to a selection key operated by a user when the selection key is operated for an amount of time that is equal to or greater than the predetermined amount of time.

5. An operation display device according to claim 2, wherein operation control unit executes a predetermined function corresponding to a selection key at the same time as the selection key is selected.

6. An operation display device according to claim 2, wherein the operation control unit causes the guide display control unit to display a guide message corresponding to a selection key while the selection key is being operated by a user, and executes a function corresponding to the selection key after a user stops operating the selection key.
